(19) United States
(12) Patent Application Publication
(10) Pub. No.: US 2024/0419765 A1
(43) Pub. Date: Dec. 19, 2024

(54) LEARNING DEVICE, LEARNING METHOD, AND LEARNING PROGRAM AND SORTING DEVICE, SORTING METHOD, AND SORTING PROGRAM

(71) Applicant: NEC Corporation, Minato-ku, Tokyo (JP)

(72) Inventor: Atsushi SATO, Tokyo (JP)

(73) Assignee: NEC Corporation, Minato-ku, Tokyo (JP)

(21) Appl. No.: 18/704,099

(22) PCT Filed: Oct. 29, 2021
(86) PCT No.: PCT/JP2021/039931

§ 371 Date: Apr. 24, 2024

(51) Int. Cl. G06F 18/2431; G06N 20/00

(52) U.S. Cl. CPC G06F 18/2431; G06N 20/00

(57) ABSTRACT

To carry out a learning technique in which a solution of a parameter is not likely to be a locally optimal solution, a learning apparatus includes: a learning means for setting a parameter (θ) included in a score function (f) for carrying out two-class classification of data, the learning means setting the parameter (θ) such that, in a square having a horizontal axis representing a false positive rate and a vertical axis representing a true positive rate, an area of a region in which the false positive rate is not more than a given threshold is minimized in a region over a receiver operating characteristic (ROC) curve obtained from a training data group.

### TECHNICAL FIELD

The present invention relates to a learning apparatus, a learning method, and a learning program each of which sets a parameter included in a score function used in two-class classification. Further, the present invention relates to a classification apparatus, a classification method, and a classification program each of which carries out two-class classification with use of a score function including a parameter.

### BACKGROUND ART

In two-class classification, a score function which receives input of data and outputs a score is used. Data a score of which is more than a threshold is classified into a positive class and data a score of which is less than the threshold is classified into a negative class. In order to carry out two-class classification accurately, a parameter included in the score function is set by machine learning. Two-class classification is used, for example, in video monitoring, failure diagnosis, inspection, medical image diagnosis, and the like in which image data is used.

As a method of machine learning in two-class classification, there is known a learning method (hereinafter also referred to as “learning method using AUC”) in which a parameter of a score function is set such that an area of an area under the curve (AUC) is maximized. Note that AUC refers to a region under a receiver operating characteristic (ROC) curve in a graph having a horizontal axis representing a false positive rate and a vertical axis representing a true positive rate. In two-class classification, there can be a case in which an amount of positive class training data is extremely small in comparison to an amount of negative class training data. It is known that even in such a case, the learning method using AUC allows a score function with a high classification accuracy to be obtained.

Further, for cases where it is possible to limit a false positive rate to not more than a predetermined threshold α and also improve a true positive rate, there has been proposed a learning method (hereinafter also referred to as “learning method using pAUC”) in which a parameter of a score function is set such that an area of a partial AUC (pAUC) is maximized. Note that pAUC refers to a region in an AUC in which region a false positive rate is not more than the threshold α (a region on a left side of a straight line representing the false positive rate=α). Examples of prior art documents disclosing a learning method using pAUC include Patent Literature 1.

### CITATION LIST

### Patent Literature

### [Patent Literature 1]

Japanese Patent Application Publication Tokukai No. 2017-102540

### SUMMARY OF INVENTION

### Technical Problem

However, the learning method using pAUC has a problem that when updating of a parameter is repeatedly carried out by a hill climbing method, a solution of the parameter tends to be a locally optimal solution. As such, two-class classification using a score function in which a parameter has been set by a learning method using pAUC has a problem that stably high accuracy cannot be achieved.

An example aspect of the present invention has been made in view of the above problem, and an example object thereof is to provide a learning technique in which a solution of a parameter is not likely to be a locally optimal solution and to provide a classification technique which can achieve stably high accuracy.

### Solution to Problem

A learning apparatus in accordance with an example aspect of the present invention is a learning apparatus, including: a learning means for setting a parameter included in a score function for carrying out two-class classification of data, wherein the learning means sets the parameter such that, in a square having a horizontal axis representing a false positive rate and a vertical axis representing a true positive rate, an area of a region in which the false positive rate is not more than a given threshold is minimized in a region over a receiver operating characteristic, ROC, curve obtained from a training data group.

A learning method in accordance with an example aspect of the present invention is a learning method by which a learning apparatus sets a parameter included in a score function for carrying out two-class classification of data, wherein the parameter included in the score function is set such that, in a square having a horizontal axis representing a false positive rate and a vertical axis representing a true positive rate, an area of a region in which the false positive rate is not more than a given threshold is minimized in a region over a receiver operating characteristic, ROC, curve obtained from a training data group.

A learning program in accordance with an example aspect of the present invention is a learning program for causing a computer to operate as the learning apparatus described above, the learning program causing the computer to function as each of the means included in the learning apparatus.

A classification apparatus in accordance with an example aspect of the present invention is a classification apparatus, including: a classification means for carrying out two-class classification of data with use of a score function, wherein a parameter included in the score function is set such that, in a square having a horizontal axis representing a false positive rate and a vertical axis representing a true positive rate, an area of a region in which the false positive rate is not more than a given threshold is minimized in a region over a receiver operating characteristic, ROC, curve obtained from a training data group.

A classification method in accordance with an example aspect of the present invention is a classification method by which a classification apparatus carries out two-class classification of data with use of a score function, wherein a parameter included in the score function is set such that, in a square having a horizontal axis representing a false positive rate and a vertical axis representing a true positive rate, an area of a region in which the false positive rate is not more than a given threshold is minimized in a region over a receiver operating characteristic, ROC, curve obtained from a training data group.

A classification program in accordance with an example aspect of the present invention is a classification program for causing a computer to operate as the classification apparatus, the classification program causing the computer to function as each of the means included in the classification apparatus.

### Advantageous Effects of Invention

According to an example aspect of the present invention, it is possible to provide a learning technique in which a solution of a parameter is not likely to be a locally optimal solution. Further, according to an example aspect of the present invention, it is possible to provide a classification technique which can achieve stably high accuracy.

### BRIEF DESCRIPTION OF DRAWINGS

FIG. 1 is a block diagram illustrating a configuration of a learning apparatus in accordance with an example embodiment of the present invention.

FIG. 2 is a flowchart illustrating a flow of a learning method carried out by the learning apparatus illustrated in FIG. 1.

FIG. 3 is a diagram illustrating an effect of the learning apparatus illustrated in FIG. 1.

FIG. 4 is a diagram illustrating an effect of the learning apparatus illustrated in FIG. 1.

FIG. 5 is a block diagram illustrating a configuration of a classification apparatus in accordance with an example embodiment of the present invention.

FIG. 6 is a flowchart illustrating a flow of a classification method carried out by the classification apparatus illustrated in FIG. 5.

FIG. 7 is a block diagram illustrating a configuration of a learning and classification apparatus in accordance with an example embodiment of the present invention.

FIG. 8 is a block diagram illustrating a hardware configuration of a computer that functions as the learning apparatus illustrated in FIG. 1, the classification apparatus illustrated in FIG. 5, or the learning and classification apparatus illustrated in FIG. 7.

### EXAMPLE EMBODIMENTS

### Definition of Terms

A score function f refers to a function a domain of definition of which is a data set X and a range of which is a real number R. The score function f includes a parameter θ. The parameter θ can be a scalar or can be a vector. A value of the score function f with respect to data x belonging to the data set X is expressed as f(x;θ). The score function f is used for two-class classification of the data x. In the two-class classification, for example, in a case where a score f(x;θ) of the data x is more than a threshold η, it is determined that the data x belongs to a positive class, and in a case where a score f(x;θ) of the data x is less than the threshold η, it is determined that the data x belongs to a negative class.

In machine learning of the score function f, N⁺ pieces of data xᵢ∈X (i is a natural number of not less than 1 and not more than N⁺) which are given a positive label and N⁻ pieces of data xⱼ∈X (j is a natural number of not less than 1 and not more than N⁻) which are given a negative label are used as training data. The training data xᵢ which are given a positive label are represented as a positive example x⁺ᵢ and the training data xⱼ which are given a negative label are represented as a negative example x⁻ⱼ. Further, a score f(x⁺ᵢ;θ) of the positive example x⁺ᵢ is represented as s⁺ᵢ, and a score f(x⁻ⱼ;θ) of the negative example x⁻ⱼ is expressed as s⁻ⱼ. A set of training data {x⁺ᵢ|1≤i≤N⁺}∪{x⁻ⱼ|1≤j≤N⁻-} is referred to as a training data group D1.

A false positive rate P_{η} refers to a real number of not less than 0 and not more than 1, defined by P_{η} =(the number of negative examples x⁻ⱼ a score s⁻ⱼ of each of which is more than the threshold η)/(a total number N⁻ of negative examples x⁻ⱼ). A true positive rate Q_{η} refers to a real number of not less than 0 and not more than 1, defined by Q_{η}=(the number of positive examples x⁺ᵢ a score s⁺ᵢ of each of which is more than the threshold η)/(a total number N⁺ of positive examples x⁺ᵢ). In a square [0, 1]×[0, 1], when a point (P_{η}, Q_{η}) is plotted while η is gradually changed, an upward-sloping curve {(P_{η}, Q_{η})|−∞<η <+∞} is obtained. This curve is referred to as a receiver operating characteristic (ROC) curve. The ROC curve divides the square [0, 1]×[0, 1] into two regions.

In the square [0, 1]×[0, 1], a region under the ROC curve is referred to as an area under the curve (AUC). In the AUC, a region in which the false positive rate P_{η} is less than a given threshold α (a region on a left side of a straight line representing P_{η}=a) is referred to as a partial AUC (AUC). An area S_{AUC} of the AUC can be calculated by an expression (1) below with reference to the N⁺ positive examples x⁺ᵢ and the N⁻ negative examples x⁻ⱼ. Note that I(⋅) is a function which has the value 1 when ⋅ is true and has the value 0 when ⋅ is false.

$${S}_{AUC} = \frac{1}{{N}^{+} {N}^{-}} {\sum }_{i = 1}^{{N}^{+}} {\sum }_{j = 1}^{{N}^{-}} I ( {s}_{i}^{+} > {s}_{j}^{-} ) \qquad ( 2 )$$

An area S_{pAUC} of the pAUC can be calculated by an expression (2) below with reference to the N⁺ positive examples x⁺ᵢ and αN⁻ negative examples x⁻ⱼ respectively having top αN⁻ scores. Note that the negative examples x⁻ⱼ are sorted in descending order of scores. That is, the relation s⁻₁>s⁻₂> . . . >S⁻_{N}⁻ is satisfied. Note that in order to perform normalization such that an area of the region on the left side of the threshold α is 1, N⁺ N⁻ which appears in the denominator of the coefficient in expression (2) can be replaced with N⁺αN⁻.

$${S}_{pAUC} = \frac{1}{{N}^{+} {N}^{-}} {\sum }_{i = 1}^{{N}^{+}} {\sum }_{j = 1}^{α {N}^{-}} I ( {s}_{i}^{+} > {s}_{j}^{-} )$$

In the square [0, 1]×[0, 1], a region over the ROC curve is referred to as an area over the curve (AOC). In the AOC, a region in which the false positive rate P_{η} is not more than the given threshold α (a region on a left side of a straight line representing P_{η}=α) is referred to as a partial AOC (pAOC). An area S_{A}OC of the AOC can be calculated by an expression (3) below with reference to p positive examples x⁺ᵢ respectively having bottom p scores and n negative examples x⁻ⱼ respectively having top n scores. Note that the negative examples x⁻ⱼ are sorted in descending order of scores, and the positive examples x⁺ᵢ are sorted in ascending order of scores. The number of positive examples x⁺ᵢ a score of each of which is lower than that of the maximum score s⁻₁ among the negative examples is p, and number of negative examples x⁻ⱼ a score of each of which is higher than that of the minimum score s⁺₁ among the positive examples is n. That is, the relation s⁻₁> . . . >s⁻ₙ>s⁺₁>s⁻ₙ₊₁> . . . >S⁻_{N}⁻ and the relation s⁺₁< . . . <s⁺ₚ<s⁻₁<s⁺ₚ₊₁< . . . <s⁺N⁺ are satisfied.

$${S}_{AOC} = \frac{1}{{N}^{+} {N}^{-}} {\sum }_{i = 1}^{p} {\sum }_{j = 1}^{n} J ( {s}_{i}^{+} \leq {s}_{j}^{-} ) \qquad ( 3 )$$

An area S_{pAOC} of the pAOC can be calculated by an expression (4) below with reference to the p positive examples x⁺ᵢ respectively having bottom p scores and the αN⁻ negative examples x⁻ⱼ respectively having top αN⁻ scores. Note that in order to perform normalization such that an area of the region on the left side of the threshold α is 1, N⁺ N⁻ which appears in the denominator of the coefficient in expression (4) can be replaced with N⁺ αN⁻.

$${S}_{pAOC} = \frac{1}{{N}^{+} {N}^{-}} {\sum }_{i = 1}^{p} {\sum }_{j = 1}^{α {N}^{-}} I ( {s}_{i}^{+} \leq {s}_{j}^{-} ) \qquad ( 4 )$$

### First Example Embodiment

The following description will discuss a first example embodiment of the present invention in detail with reference to the drawings. The present example embodiment is a basic form of each example embodiment described later.

### (Configuration of Learning Apparatus)

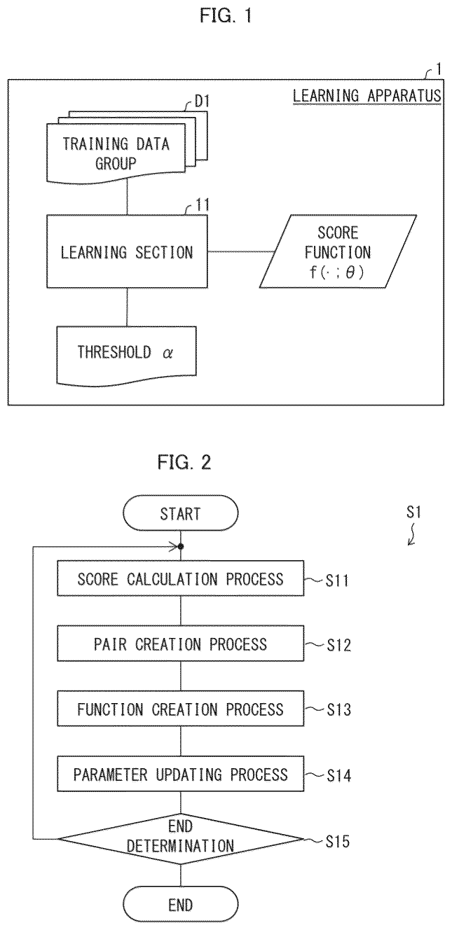

A configuration of a learning apparatus 1 in accordance with the present example embodiment will be described with reference to FIG. 1. FIG. 1 is a block diagram illustrating the configuration of the learning apparatus 1.

The learning apparatus 1 is an apparatus for optimizing, by machine learning, a score function f for carrying out two-class classification of data. The learning apparatus 1 includes a learning section 11 as illustrated in FIG. 1. The learning section 11 is an example embodiment of a learning means recited in Claims.

The learning section 11 sets a parameter included in a score function for carrying out two-class classification of data, wherein the learning section 11 sets the parameter such that, in a square having a horizontal axis representing a false positive rate and a vertical axis representing a true positive rate, an area of a region in which the false positive rate is not more than a given threshold is minimized in a region over a receiver operating characteristic (ROC) curve obtained from a training data group. A function of the learning section 11 will be described below in detail.

The learning section 11 is a means for setting a parameter θ included in the score function f such that an area S_{pAOC} of pAOC determined from a training data group D1 and a threshold α is minimized.

The learning section 11, for example, sets the parameter θ by a hill descending method with use of a differentiable function S_{pAOC}(θ) which approximates the area S_{pAOC}. That is, the learning section 11 sets the parameter θ by repeating a process of causing the parameter θ to change in a direction in which a gradient ∂S_{pAOC}(θ)/∂θ of the function S_{pAOC}(θ) is minimized. For example, in a case where the S_{pAOC} is given by expression (4) above, the function S_{pAOC}(θ) is given by an expression (5) below. Note that g(⋅) is a differentiable monotonically increasing function, and is, for example, a sigmoid function or a hinge function.

$${S}_{pAOC} ( θ ) = \frac{1}{{N}^{+} α {N}^{-}} {\sum }_{i = 1}^{p} {\sum }_{j = 1}^{{αN}^{-}} g ( f ( {x}_{j}^{-} ; θ ) - f ( {x}_{i}^{+} ; θ ) ) \qquad ( 5 )$$

Note that the direction in which the gradient ∂S_{pAOC}(θ)/∂θ of the differentiable function S_{pAOC}(θ) which approximates the area S_{pAOC} of the pAOC is minimized and the direction in which the gradient ∂S_{pAOC}(θ)/∂θ of the differentiable function S_{pAUC}(θ) which approximates an area S_{pAUC} of pAUC is maximized do not coincide with each other. As such, the process of setting the parameter θ by the hill descending method with use of the function S_{pAOC}(θ) is practically different from the process of setting the parameter θ by the hill climbing method with use of the function S_{pAUC}(θ).

Note that the learning apparatus 1 can further include a training data group storage section which stores therein the training data group D1. Further, the learning apparatus 1 can further include a threshold storage section which stores therein the threshold α. Further, the learning apparatus 1 can further include a threshold setting section which sets the threshold α in accordance with a user operation.

### (Operation of Learning Apparatus)

A specific example of a learning method S1 carried out by the learning apparatus 1 will be described with reference to FIG. 2. FIG. 2 is a flowchart illustrating a flow of the learning method S1.

The learning method S1 is a learning method by which the learning apparatus sets a parameter included in a score function for carrying out two-class classification of data, wherein the parameter included in the score function is set such that, in a square having a horizontal axis representing a false positive rate and a vertical axis representing a true positive rate, an area of a region in which the false positive rate is not more than a given threshold is minimized in a region over a receiver operating characteristic (ROC) curve obtained from a training data group. The learning method S1 will be described below in detail.

As illustrated in FIG. 2, the learning method S1 includes a score calculation process S11, a pair creation process S12, a function creation process S13, a parameter updating process S14, and an end determination process S15. The score calculation process S11, the pair creation process S12, the function creation process S13, the parameter updating process S14, and the end determination process S15 are carried out, for example, by the above-described learning section 11.

The score calculation process S11 is a process of calculating, with use of the score function f, (i) a score s⁺ᵢ=f(x⁺ᵢ;θ) of each of N⁺ positive examples x⁺ᵢ and (ii) a score s⁻ⱼ=f(x⁻ⱼ;θ) of each of N⁻ negative examples x⁻ⱼ.

The pair creation process S12 is a process of creating a score pair to be referred to in order to calculate the area S_{pAOC} of the pAOC. In the pair creation process S12, the learning section 11, for example, carries out the following steps. Firstly, the learning section 11 sorts the positive examples x⁺ᵢ in ascending order of scores and sorts the negative examples x⁻ⱼ in descending order of scores. Secondly, the learning section 11 creates pΔαN⁻ pairs (x⁺ᵢ, x⁻ⱼ) by combining the p positive examples x⁺ᵢ respectively having bottom p scores with the αN⁻-negative examples x⁻ⱼ respectively having top αN⁻ scores. Note that p is a natural number satisfying the relation s⁺ₚ<s⁻₁<s⁺ₚ₊₁.

The function creation process S13 is a process of creating, with use of the pΔαN⁻ pairs (x⁺ᵢ, x⁻ⱼ) created in the pair creation process S12, a differentiable function S_{pAOC}(θ) which approximates the area S_{pAOC}. Note that the function S_{pAOC}(θ), for example, is given by expression (5) above.

The parameter updating process S14 is a process of updating the parameter θ with use of the gradient ∂S_{pAOC}(θ)/∂θ of the function S_{pAOC}(θ) created in the function creation process S13. In the parameter updating process S14, the learning section 11, for example, carries out the following steps. Firstly, the parameter updating process S14 derives the gradient ∂S_{pAOC}(θ)/∂θ of the function S_{pAOC}(θ). Secondly, the parameter updating process S14 updates the parameter θ by expression (6) below with use of a predetermined very small positive real number ε.

$$θ ← θ - ϵ \frac{\partial {S}_{pAOC} ( θ )}{\partial θ} \qquad ( 6 )$$

The end determination process S15 is a process of determining whether or not the parameter θ updated in the parameter updating process S14 satisfies a predetermined end condition. The learning section 11 repeats the score calculation process S11, the pair creation process S12, the function creation process S13, and the parameter updating process S14 described above until a parameter θ satisfying the end condition is obtained. Then, the learning section 11 ends the learning method S1 when the parameter θ satisfying the end condition is obtained.

### (Effect of Learning Apparatus)

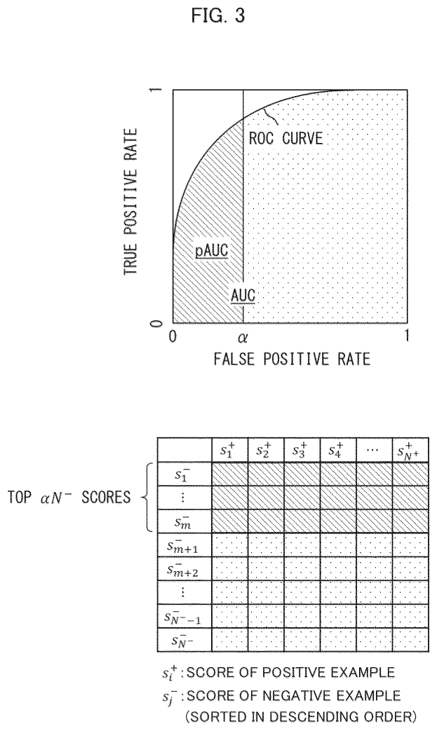

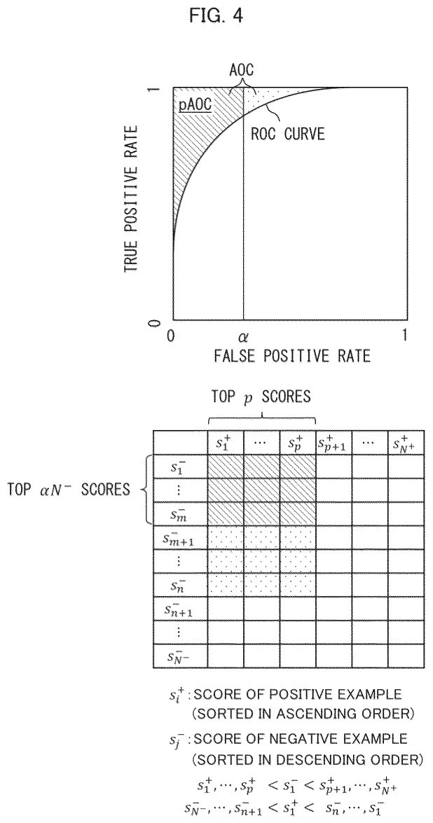

The learning method S1 using pAOC provides an effect that a solution of the parameter θ is less likely to be a locally optimal solution, in comparison with a learning method using pAUC. This effect will be described with reference to FIGS. 3 and 4.

FIG. 3 is a diagram for describing a learning method using pAUC.

In an upper part of FIG. 3, AUC and pAUC in a square [0,1]×[0,1] are shown. In the upper part of FIG. 3, a hatched region is pAUC. Further, a region that is a combination of the hatched region and a region indicated with halftone dots is AUC. A lower part of FIG. 3 shows a list of pairs of a positive example and a negative example. In the lower part of FIG. 3, hatched pairs are pairs which are referred to when a parameter is set such that pAUC is maximized. Further, both the hatched pairs and pairs indicated with halftone dots are pairs which are referred to when a parameter is set such that AUC is maximized.

With reference to the upper part of FIG. 3, it should be that the parameter θ is set by taking into consideration the entire AUC, but in learning using pAUC, the region that is taken into consideration is limited to pAUC. Note here that the region not taken into consideration, that is, the region obtained by eliminating pAUC from AUC is larger than the region pAUC which is taken into consideration. As such, in learning using pAUC, a solution of the parameter θ tends to be a locally optimal solution. This undesirable tendency becomes more significant as the threshold α decreases.

FIG. 4 is a diagram for describing a learning method using pAOC.

In an upper part of FIG. 4, AOC and pAOC in a square [0,1]×[0,1] are shown. In the upper part of FIG. 4, a hatched region is pAOC. Further, a region that is a combination of the hatched region and a region indicated with halftone dots is AOC. A lower part of FIG. 4 shows a list of pairs of a positive example and a negative example. In the lower part of FIG. 4, hatched pairs are pairs which are referred to when a parameter is set such that pAOC is minimized. Further, both the hatched pairs and pairs indicated with halftone dots are pairs which are referred to when a parameter is set such that AOC is minimized.

With reference to the upper part of FIG. 4, it should be that the parameter θ is set by taking into consideration the entire AOC, but in learning using pAOC, the region that is taken into consideration is limited to pAOC. However, the region not taken into consideration, that is, the region obtained by eliminating pAOC from AOC is smaller than the region pAOC which is taken into consideration. As such, in learning using pAOC, it is less likely that a solution of the parameter θ is a locally optimal solution.

### Second Example Embodiment

The following description will discuss a second example embodiment of the present invention in detail with reference to the drawings. The same reference numerals are given to constituent elements which have functions identical to those described in the first example embodiment, and descriptions as to such constituent elements are omitted as appropriate.

### (Configuration of Classification Apparatus)

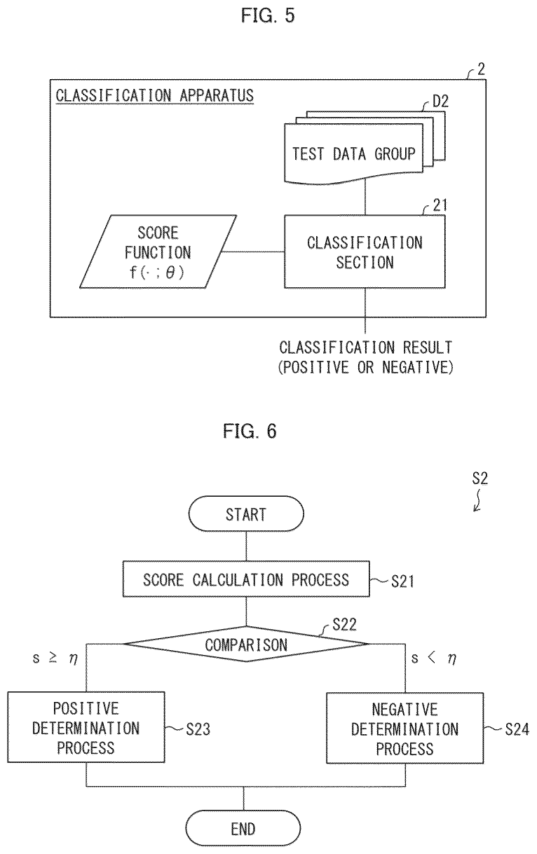

A configuration of a classification apparatus 2 in accordance with the present example embodiment will be described with reference to FIG. 5. FIG. 5 is a block diagram illustrating the configuration of the classification apparatus 2.

The classification apparatus 2 is an apparatus for carrying out two-class classification of data with use of a score function f. The classification apparatus 2 includes a classification section 21 as illustrated in FIG. 5. The classification section 21 is an example embodiment of a classification means recited in Claims.

The classification section 21 is a means for carrying out, with use of the score function f, two-class classification of data x belonging to a test data group D2. The score function f is a score function in which a parameter θ is set such that an area S_{pAOC} of pAOC determined from a training data group D1 is minimized.

Note that the classification apparatus 2 obtains the parameter θ or the score function f including the parameter θ, for example, from the learning apparatus 1 described above. This makes it possible to carry out two-class classification with use of the score function f in which the parameter θ is set such that the area S_{pAOC} of pAOC determined from the training data group D1 is minimized.

Note that the classification apparatus 2 can further include a test data group storage section which stores therein the test data group D2.

### (Operation of Classification Apparatus)

A specific example of a classification method S2 carried out by the classification apparatus 2 will be described with reference to FIG. 6. FIG. 6 is a flowchart illustrating a flow of the classification method S2.

The classification method S2 is a method by which a classification apparatus carries out two-class classification of data with use of a score function, wherein a parameter included in the score function is set such that, in a square having a horizontal axis representing a false positive rate and a vertical axis representing a true positive rate, an area of a region in which the false positive rate is not more than a given threshold is minimized in a region over a receiver operating characteristic, ROC, curve obtained from a training data group. The classification method S2 will be described below in detail.

As illustrated in FIG. 6, the classification method S2 includes a score calculation process S21, a comparison process S22, a positive determination process S23, and a negative determination process S24. The score calculation process S21, the comparison process S22, the positive determination process S23, and the negative determination process S24 are carried out, for example, by the above-described classification section 21.

The score calculation process S21 is a process of calculating a score s=f(x;θ) by inputting the data x to the score function f.

The comparison process S22 is a process of comparing the score s calculated in the score calculation process S21 with a threshold η.

In a case where the score s is not less than the threshold η or is more than the threshold η (for example, in a case where s≥η), the positive determination process S23 is carried out.

The positive determination process S23 is a process of determining that the data x is a positive class.

In a case where the score s is not more than the threshold η or is less than the threshold η (for example, in a case where s<η), the negative determination process S24 is carried out.

The negative determination process S24 is a process of determining that the data x is a negative class.

### (Effect of Classification Apparatus)

The parameter included in the score function f referred to by the classification apparatus 2 is set such that an area of pAUC is minimized. As such, according to the classification apparatus 2, it is possible to carry out two-class classification with stably high accuracy.

### Third Example Embodiment

The following description will discuss a third example embodiment of the present invention in detail with reference to the drawings. The same reference numerals are given to constituent elements which have functions identical to those described in the first example embodiment and the second example embodiment, and descriptions as to such constituent elements are omitted as appropriate.

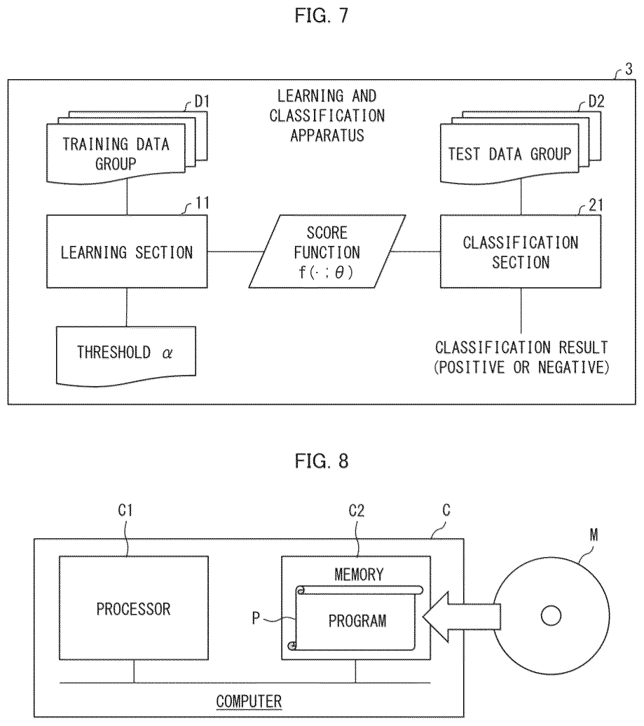

A configuration of a learning and classification apparatus 3 in accordance with the present example embodiment will be described with reference to FIG. 7. FIG. 7 is a block diagram illustrating the configuration of the learning and classification apparatus 3.

The learning and classification apparatus 3 is an apparatus which serves as both the learning apparatus 1 and the classification apparatus 2 described above. The learning and classification apparatus 3 includes a learning section 11 and a classification section 21 as illustrated in FIG. 7.

The learning section 11 is a means for setting a parameter θ included in a score function f such that an area S_{pAOC} of pAOC determined from a training data group D1 is minimized, as described above. The classification section 21 is a means for carrying out, with use of the score function f, two-class classification of data x belonging to a test data group D2, as described above.

In the learning and classification apparatus 3, (1) the learning section 11 carries out the above-described learning method S1 to thereby set the parameter θ included in the score function f, and (2) the classification section 21 carries out the above-described classification method S2 to thereby carry out two-class classification of the data x. This allows both learning and classification to be carried out using a single apparatus.

### Software Implementation Example

Some or all of the functions of each of the learning apparatus 1, the classification apparatus 2, and the learning and classification apparatus 3 (hereinafter referred to as “learning apparatus etc.”) can be realized by hardware such as an integrated circuit (IC chip) or can be alternatively realized by software.

In the latter case, the learning apparatus etc. are each realized by, for example, a computer that executes instructions of a program that is software realizing the foregoing functions. FIG. 8 illustrates an example of the computer (hereinafter referred to as “computer C”). The computer C includes at least one processor C1 and at least one memory C2. The at least one memory C2 stores a program P for causing the computer C to operate as the learning apparatus etc. In the computer C, the foregoing functions of the learning apparatus etc. can be realized by the at least one processor C1 reading and executing the program P stored in the at least one memory C2.

The at least one processor C1 can be, for example, a central processing unit (CPU), a graphic processing unit (GPU), a digital signal processor (DSP), a micro processing unit (MPU), an floating point number processing unit (FPU), a physics processing unit (PPU), a microcontroller, or a combination thereof. The at least one memory C2 can be, for example, a flash memory, a hard disk drive (HDD), a solid state drive (SSD), or a combination thereof.

Note that the computer C may further include a random access memory (RAM) in which the program P is loaded when the program P is executed and in which various kinds of data are temporarily stored. The computer C may further include a communication interface for carrying out transmission and reception of data to and from another apparatus. The computer C may further include an input-output interface for connecting input-output apparatuses such as a keyboard, a mouse, a display, and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via such a storage medium M. The program P can be transmitted via a transmission medium. The transmission medium can be, for example, a communications network, a broadcast wave, or the like. The computer C can obtain the program P also via such a transmission medium.

### [Additional Remark 1]

The present invention is not limited to the above example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

The whole or part of the example embodiments disclosed above can be described as, but not limited to, the following supplementary notes.

### (Supplementary Note 1)

A learning apparatus, including: a learning means for setting a parameter included in a score function for carrying out two-class classification of data, wherein the learning means sets the parameter such that, in a square having a horizontal axis representing a false positive rate and a vertical axis representing a true positive rate, an area of a region in which the false positive rate is not more than a given threshold is minimized in a region over a receiver operating characteristic, ROC, curve obtained from a training data group.

According to the above configuration, it is possible to provide a learning technique in which a solution of a parameter is not likely to be a locally optimal solution.

### (Supplementary Note 2)

The learning apparatus described in supplementary note 1, wherein the learning means sets the parameter by a hill descending method with use of a differentiable function which approximates the area.

According to the above configuration, it is possible to provide a learning technique in which a solution of a parameter is not likely to be a locally optimal solution.

### (Supplementary Note 3)

The learning apparatus described in supplementary note 2, wherein the learning means sets the parameter by repeating the following processes (1) to (4) until a predetermined end condition is satisfied: (1) a score calculation process of calculating, with use of the score function, (i) a score s⁺ᵢ of each of N⁺ positive examples x⁺ᵢ included in training data and (ii) a score s⁻ⱼ of each of N⁻ negative examples x⁻ⱼ included in the training data; (2) a pair creation process of sorting the N⁺ positive examples x⁺ᵢ in ascending order of scores and the N⁻ negative examples x⁻ⱼ in descending order of scores and then combining p positive examples x⁺ᵢ respectively having bottom p scores with αN⁻ negative examples x⁻ⱼ respectively having top αN⁻ scores to thereby create pΔαN⁻ pairs (x⁺ᵢ, x⁻ⱼ) where p is a natural number satisfying s⁺ₚ<s⁻₁<s⁺ₚ₊₁ and a is the threshold; (3) a function creation process of creating, with use of the pΔαN⁻ pairs (x⁺ᵢ, x⁻ⱼ), the differentiable function which approximates the area; and (4) a parameter updating process of updating the parameter with use of a gradient of the function.

According to the above-described configuration, it is possible to accurately set an appropriate parameter.

### (Supplementary Note 4)

A learning method by which a learning apparatus sets a parameter included in a score function for carrying out two-class classification of data, wherein the parameter included in the score function is set such that, in a square having a horizontal axis representing a false positive rate and a vertical axis representing a true positive rate, an area of a region in which the false positive rate is not more than a given threshold is minimized in a region over a receiver operating characteristic, ROC, curve obtained from a training data group.

According to the above method, it is possible to carry out learning in which a solution of a parameter is not likely to be a locally optimal solution.

### (Supplementary Note 5)

A learning program for causing a computer to operate as a learning apparatus described in any one of supplementary notes 1 to 3, the learning program causing the computer to function as each of the means included in the learning apparatus.

### (Supplementary Note 6)

A classification apparatus, including: a classification means for carrying out two-class classification of data with use of a score function, wherein a parameter included in the score function is set such that, in a square having a horizontal axis representing a false positive rate and a vertical axis representing a true positive rate, an area of a region in which the false positive rate is not more than a given threshold is minimized in a region over a receiver operating characteristic, ROC, curve obtained from a training data group.

According to the above configuration, it is possible to provide a classification technique which can achieve stably high accuracy.

### (Supplementary Note 7)

A classification method, including: a classification apparatus carrying out two-class classification of data with use of a score function, wherein a parameter included in the score function is set such that, in a square having a horizontal axis representing a false positive rate and a vertical axis representing a true positive rate, an area of a region in which the false positive rate is not more than a given threshold is minimized in a region over a receiver operating characteristic, ROC, curve obtained from a training data group.

According to the above method, it is possible to provide a classification technique which can achieve stably high accuracy.

### (Supplementary Note 8)

A classification program for causing a computer to operate as a classification apparatus described in supplementary note 6, the classification program causing the computer to function as each of the means included in the classification apparatus.

### (Supplementary Note 9)

A method for producing a score function for carrying out two-class classification of data, including setting a parameter included in the score function such that, in a square having a horizontal axis representing a false positive rate and a vertical axis representing a true positive rate, an area of a region in which the false positive rate is not more than a given threshold is minimized in a region over a receiver operating characteristic, ROC, curve obtained from a training data group.

According to the above method, it is possible to provide a classification technique which can achieve stably high accuracy.

### (Supplementary Note 10)

A score function for causing a computer to carry out two-class classification of data, wherein a parameter included in the score function is set such that, in a square having a horizontal axis representing a false positive rate and a vertical axis representing a true positive rate, an area of a region in which the false positive rate is not more than a given threshold is minimized in a region over a receiver operating characteristic, ROC, curve obtained from a training data group.

According to the above configuration, it is possible to provide a classification technique which can achieve stably high accuracy.

### (Supplementary Note 11)

A learning apparatus, including: a learning means for setting a parameter included in a score function for carrying out two-class classification of data, wherein the learning means sets the parameter such that, in a square having a horizontal axis representing a false positive rate and a vertical axis representing a true positive rate, an area of a region over a receiver operating characteristic, ROC, curve obtained from a training data group is minimized.

According to the above configuration, it is possible to provide a learning technique in which a solution of a parameter is not likely to be a locally optimal solution.

### (Supplementary Note 12)

A learning method, including: a learning apparatus setting a parameter included in a score function for carrying out two-class classification of data, wherein the parameter included in the score function is set such that, in a square having a horizontal axis representing a false positive rate and a vertical axis representing a true positive rate, an area of a region over a receiver operating characteristic, ROC, curve obtained from a training data group is minimized.

According to the above method, it is possible to provide a learning technique in which a solution of a parameter is not likely to be a locally optimal solution.

### (Supplementary Note 13)

A classification apparatus, including: a classification means for carrying out two-class classification of data with use of a score function, wherein a parameter included in the score function is set such that, in a square having a horizontal axis representing a false positive rate and a vertical axis representing a true positive rate, an area of a region over a receiver operating characteristic, ROC, curve obtained from a training data group is minimized.

According to the above configuration, it is possible to provide a classification technique which can achieve stably high accuracy.

### (Supplementary Note 14)

A classification method, including: a classification apparatus carrying out two-class classification of data with use of a score function, wherein a parameter included in the score function is set such that, in a square having a horizontal axis representing a false positive rate and a vertical axis representing a true positive rate, an area of a region over a receiver operating characteristic, ROC, curve obtained from a training data group is minimized.

According to the above configuration, it is possible to provide a classification technique which can achieve stably high accuracy.

### [Additional Remark 3]

Furthermore, some of or all of the above example embodiments can also be expressed as below.

A learning apparatus, including at least one processor, the at least one processor being configured to carry out a learning process of setting a parameter included in a score function for carrying out two-class classification of data, wherein the learning process sets the parameter such that, in a square having a horizontal axis representing a false positive rate and a vertical axis representing a true positive rate, an area of a region in which the false positive rate is not more than a given threshold is minimized in a region over a receiver operating characteristic, ROC, curve obtained from a training data group.

Note that the learning apparatus may further include a memory, which may store a program for causing the at least one processor to carry out the learning process. Alternatively, the program may be stored in a non-transitory, tangible computer-readable storage medium.

### REFERENCE SIGNS LIST

1: learning apparatus
11: learning section
2: classification apparatus
21: classification section
3: learning and classification apparatus

What is claimed is:

1. A learning apparatus, comprising:
at least one processor, the at least one processor carrying out a learning process of setting a parameter included in a score function for carrying out two-class classification of data, wherein
in the learning process, the at least one processor sets the parameter such that, in a square having a horizontal axis representing a false positive rate and a vertical axis representing a true positive rate, an area of a region in which the false positive rate is not more than a given threshold is minimized in a region over a receiver operating characteristic, ROC, curve obtained from a training data group.

2. The learning apparatus according to claim 1, wherein in the learning process, the at least one processor sets the parameter by a hill descending method with use of a differentiable function which approximates the area.

3. The learning apparatus according to claim 2, wherein in the learning process, the at least one processor sets the parameter by repeating the following processes (1) to (4) until a predetermined end condition is satisfied: (1) a score calculation process of calculating, with use of the score function, (i) a score s⁺ᵢ of each of N⁺ positive examples x⁺ᵢ included in training data and (ii) a score s⁻ⱼ of each of N⁻ negative examples x⁻ⱼ included in the training data; (2) a pair creation process of sorting the N⁺ positive examples x⁺ᵢ in ascending order of scores and the N⁻ negative examples x⁻ⱼ in descending order of scores and then combining p positive examples x⁺ᵢ respectively having bottom p scores with αN⁻ negative examples x⁻ⱼ respectively having top αN⁻ scores to thereby create pΔαN⁻ pairs (x⁺ᵢ, x⁻ⱼ) where p is a natural number satisfying s⁺ₚ<s⁻₁<s⁺ₚ₊₁ and α is the threshold; (3) a function creation process of creating, with use of the pΔαN⁻ pairs (x⁺ᵢ, x⁻ⱼ), the differentiable function which approximates the area; and (4) a parameter updating process of updating the parameter with use of a gradient of the function.

4. A learning method by which a learning apparatus sets a parameter included in a score function for carrying out two-class classification of data, wherein
the parameter included in the score function is set such that, in a square having a horizontal axis representing a false positive rate and a vertical axis representing a true positive rate, an area of a region in which the false positive rate is not more than a given threshold is minimized in a region over a receiver operating characteristic, ROC, curve obtained from a training data group.

5. A computer-readable non-transitory storage medium storing therein a learning program for causing a computer to carry out a learning process recited in claim 1.

6. A classification apparatus, comprising:
at least one processor, the at least one processor carrying out a classification process of carrying out two-class classification of data with use of a score function, wherein
a parameter included in the score function is set such that, in a square having a horizontal axis representing a false positive rate and a vertical axis representing a true positive rate, an area of a region in which the false positive rate is not more than a given threshold is minimized in a region over a receiver operating characteristic, ROC, curve obtained from a training data group.

7. (canceled)

8. A computer-readable non-transitory storage medium storing therein a classification program for causing a computer to carry out a classification process recited in claim 6.
